(19) United States
(12) Patent Application Publication
(10) Pub. No.: US 2025/0092841 A1
(43) Pub. Date: Mar. 20, 2025

(54) CYLINDER LINER FOR AN INTERNAL COMBUSTION ENGINE AND A METHOD OF PRODUCING THE SAME

(71) Applicant: INNIO Jenbacher GmbH & Co OG, Jenbach (AT)

(72) Inventors: Wolfgang Fimml, Maurach in Tirol (AT); Nikolaus Spyra, Innsbruck (AT); Richard Donahue, West Bend, WI (US); Hubert Galuszka, Jenbach (AT)

(21) Appl. No.: 18/294,118

(22) PCT Filed: Aug. 4, 2021
(86) PCT No.: PCT/AT2021/060268

§ 371 Date: Jan. 31, 2024

(51) Int. Cl. F02F 1/00

(52) U.S. Cl. CPC F02F 1/004

(57) ABSTRACT

Cylinder liner for an internal combustion engine, the cylinder liner comprising an outer wall configured to be fitted in a cylinder liner bore of a crank case, and an inner circular wall forming at least partly a gliding surface for a reciprocating piston with at least one piston ring during operation of the internal combustion engine, wherein in at least a part of an area of the inner circular wall which is not reached by the at least one piston ring during reciprocation of the piston a coating which serves as an anti-polishing ring is arranged.

### CROSS-REFERENCE TO RELATED APPLICATION

This application is a National Stage entry from, and claims benefit of, PCT Application No. PCT/AT2021/060268, filed on Aug. 4, 2021, entitled “CYLINDER LINER FOR AN INTERNAL COMBUSTION ENGINE AND A METHOD OF PRODUCING THE SAME”, which is herein incorporated by reference in its entirety.

### BACKGROUND

The present invention concerns a cylinder liner for an internal combustion engine with the features of the classifying portion as described herein and a method of producing the same. The present invention further concerns a cylinder-piston unit and/or an internal combustion engine with such a cylinder liner.

The use of cylinder liners is well known in the field of internal combustion engines. It is also known to use anti-polishing rings (or so called “scraper rings”) being capable of scraping off deposits from the top land of a piston crown. Conventionally, anti-polishing rings or scraper rings are ring-like components, which are fitted into the cylinder liner inner wall, such as described in U.S. Pat. No. 9,562,491 B2 or US 2021/0062753 A1.

Document U.S. Pat. No. 9,562,491 B2 discloses a cylinder liner comprising a scraper ring for preventing and removing carbon deposit build-up on a piston/cylinder assembly. The scraper ring comprises a coating to increase wear resistance.

Document US 2021/0062753 A1 also discloses a cylinder liner comprising a scraper ring with the difference that the piston top land comprises a non-abrasion-proof coating.

A disadvantage of known embodiments is that the scraper ring or anti-polishing ring is a separate component—namely separated from the cylinder liner—which needs to be fitted into a dedicated recess in a cylinder liner top portion. Due to the manufacturing process of such recesses, either the anti-polishing ring has to comprise a chamfer or the recess has to have an undercut, both in the area of the edge formed by the transition of the recess diameter to the plane surface (facing axially), naturally leading to a free space (crevice volume).

Additionally, by using such a scraper ring, also crevice volumes in the area of the cylinder head sealing are created. The cylinder head should not sit directly on the scraper ring, because this would lead to unfavorable mechanical stress in the cylinder liner, leading to a free space between the front face of the scraper ring and the cylinder head.

Such a free space is unfavorable, since due to the varying pressure relationships during a combustion cycle, fuel gas (e.g., natural gas) is pressed into the crevice volume at high pressure conditions (compression stroke) and released as unburned fuel back into the combustion chamber during low pressure conditions (e.g., during the exhaust stroke). This leads to an undesired release of HC emissions into the atmosphere.

### BRIEF DESCRIPTION

An aspect of the present invention is therefore to provide a cylinder liner for an internal combustion engine with an anti-polishing mechanism, wherein HC emissions can be reduced.

This aspect is achieved with a cylinder liner with the features set forth in the claims. The purpose is further solved by a cylinder-piston unit and/or an internal combustion engine with the features set forth in the claims.

According to a first embodiment of the invention, a cylinder liner for an internal combustion engine comprises:
an outer wall configured to be fitted in a cylinder liner bore of a crank case, and
an inner circular wall forming at least partly a gliding surface for a reciprocating piston with at least one piston ring during operation of the internal combustion engine,
   Wherein, in at least a part of an area of the inner circular wall which is not reached by the at least one piston ring during reciprocation of the piston, a coating which serves as an anti-polishing ring is arranged.

By a second embodiment of the present invention, the cylinder liner comprises:
an outer wall configured to be fitted in a cylinder liner bore of a crank case, and
an inner circular wall having a diameter forming at least partly a gliding surface for a reciprocating piston with at least one piston ring during operation of the internal combustion engine,
   wherein the cylinder liner comprises a front face facing a cylinder head in a mounted state of the cylinder liner, wherein, in at least a part of an area of the inner circular wall, a coating which serves as an anti-polishing ring is arranged, wherein the area extends along the longitudinal axis of the cylinder liner starting from the front face along a length of maximally 30%, preferably maximally 20%, of the diameter of the inner circular wall.

Formulated differently, the coating which serves as a scraper ring extends no further axially down the cylinder liner than a certain length, the certain length being maximally 30%, preferably maximally 20%, of the diameter of the inner circular wall of the cylinder liner.

Preferably, in certain embodiments, the coating is not arranged outside of the area. Embodiments where the coating is also arranged in certain areas outside the area are in principle conceivable. However, in certain embodiments, the coating should not extend further down the length of the cylinder liner as the coating would then not be able to function as scraper ring.

Of course, there can also be other coatings, which are disposed on the inner wall of the cylinder liner.

According to certain embodiments of the invention, it can be provided that the anti-polishing ring (or also called the scraper ring) is provided by a coating, which coating is provided on an inner wall of the cylinder liner, wherein no recess, groove or chamber has to be provided to receive a separate component part.

Additionally, due to the small thickness (in a range between 40 and 200 micrometers) of the coating serving as a scraper ring, the crevice volume in the area of the cylinder head gasket is reduced, even when the coating is reaching the front face of the cylinder liner.

By the avoidance of such geometries and a separate component part, the crevice volumes can be reduced or can be eliminated. The reduction or elimination of the crevice volumes reduces the unburned fuel volume, because the fuel and/or air-fuel mixture supplied to the combustion chamber cannot any more escape into cavities between the cylinder liner and the anti-polishing ring, such that more fuel is combusted by the combustion and the HC-emissions are reduced (by reducing unburned fuel in the exhaust gas).

Furthermore, by giving up the separate component part of the anti-polishing ring, the total number of component parts of a cylinder-piston unit can be reduced, wherein the assembly and disassembly time (and work) can be reduced.

It has been recognized by the inventors that the function of an anti-polishing ring provided by a coating has much better properties and characteristics compared to anti-polishing rings provided by separate component parts, wherein the maintenance work can be reduced as it is no longer necessary to change the anti-polishing rings after a given period of time.

Also, the manufacturing efforts can be reduced as the cylinder liner can be manufactured without chamfers, recesses, undercuts and/or grooves, which have been necessary for receiving the anti-polishing ring.

A further advantage of embodiments of the present invention is that the thermal conditions in the area of the coating (anti-polishing ring) can be improved, because the thermal load transferred into the anti-polishing ring by the combustion can be dissipated into the cylinder liner in a better way as they are provided by the same component (and there is no longer a gap between the separate component parts, which would impede the heat flow).

Preferred embodiments are defined in the dependent claims.

It can be provided, that the thickness of the coating is in a range between 40 and 200 micrometers.

Preferably, it is provided, that the coating has an extension along the longitudinal axis of the cylinder liner in a range between 3 mm and 60 mm.

It can be provided, that the coating is arranged in an area of a top portion of the cylinder liner, which is close to a cylinder head of the internal combustion engine when the cylinder liner is arranged in the cylinder liner bore of the crank case.

Preferably, it is provided, that the coating extends from a front face of the top portion of the cylinder liner to a distance 60 mm away from the front face along the longitudinal axis of the cylinder liner.

It can be provided, that the coating extends in a range of 57 mm to 60 mm away of a front face of the top portion of the cylinder liner.

Preferably, it is provided, that the coating is essentially continuous around the entire inner circular wall.

It can be provided, that the coating is applied directly onto the inner circular wall, wherein the entire inner circular wall is a continuous surface along the entire longitudinal axis and preferably circumferential.

Preferably, it is provided, that the material of the coating is Co-, Ti- or Ni-based alloy or ceramics.

Furthermore, protection is sought for a process for manufacturing a cylinder liner with a coating, preferably a cylinder liner according to the first or the second embodiment of the invention, wherein the cylinder liner is manufactured via at least one conventional manufacturing process from the group of casting, turning, milling or additive manufacturing, preferably wherein essentially the entire inner circular wall is treated by conventional surface treatment process from the group of grinding or honing to create a specific surface roughness, wherein a coating is applied via a weld cladding or brazing process only onto at least one part of an area of the inner circular wall
which area is not reached by at least one piston ring during reciprocation of a piston, and/or
which area (5) extends along the longitudinal axis (7) of the cylinder liner (1) starting from the front face (8) along a length of maximally 30%, preferably maximally 20%, of the diameter of the inner circular wall (3).

Also, protection is sought for a cylinder liner obtainable by such a process.

It can be provided, that the coating is applied via a laser cladding process. By a laser cladding process, very precise and/or thin cladding layers can be built up on a base material. Therefore, it can be provided, that the finished surface can be provided by the laser cladding process, wherein a finishing manufacturing method (as polishing, honing, lapping and so on) is redundant.

Preferably, it can be provided, that the coating is post-treated by turning, milling, honing or grinding.

It can be provided, that the inner circular wall of the cylinder liner is manufactured with essentially constant diameter by at least one conventional manufacturing process in a first step, and wherein in a second step the coating is applied on the inner wall, wherein the inner diameter of the inner circular wall is decreased in the area by the coating.

An essentially constant diameter has to be understood as a diameter which (of course) differs from an ideal geometrical and/or numeral diameter, e.g., in consequence of manufacturing tolerances, deviations from fabrication and/or manufacturing errors.

For other embodiments, especially in the case of a so called tight top land configuration, where the protrusion of the coating into the combustion chamber is below 100 micrometers, it can be provided, that a recess with a depth of up to 100 micrometers can be provided at the inner wall of the cylinder liner, preferably the recess can be provided only in the area where the coating is applied.

Protection is also sought for a cylinder-piston unit for an internal combustion engine, comprising a cylinder liner according the first and/or the second embodiment of the invention and a piston with at least one piston ring, wherein the at least one piston ring is distanced from a top surface of a piston crown, wherein the piston is moveably arranged in the cylinder liner and reciprocates during the operation of the internal combustion engine, characterized in that at least a part of an area of the inner circular wall of the cylinder liner which is not reached by the at least one piston ring during reciprocation of the piston a coating is arranged, which serves as an anti-polishing ring.

It can be provided, that the coating is distanced away in range between 0.1 and 2 mm from the at least one piston ring of the piston along a longitudinal axis of the cylinder liner when the piston is in the top dead center position and extends at least to the top surface of the piston crown.

### BRIEF DESCRIPTION OF THE DRAWINGS

Further details and advantages of the invention are apparent from the accompanying figures and the following description of the figures. The figures show:

FIG. 1 illustrates an embodiment of a cylinder liner having an anti-polishing ring disposed in a recess,

FIG. 2 illustrates a first embodiment of a cylinder liner according to the invention,

FIG. 3 illustrates a second embodiment of a cylinder liner according to the invention,

FIG. 4 illustrates a fist embodiment of an internal combustion engine according to the invention in the area of a cylinder-piston unit, and

FIG. 5 illustrates a second embodiment of an internal combustion engine according to the invention in the area of a cylinder-piston unit.

### DETAILED DESCRIPTION

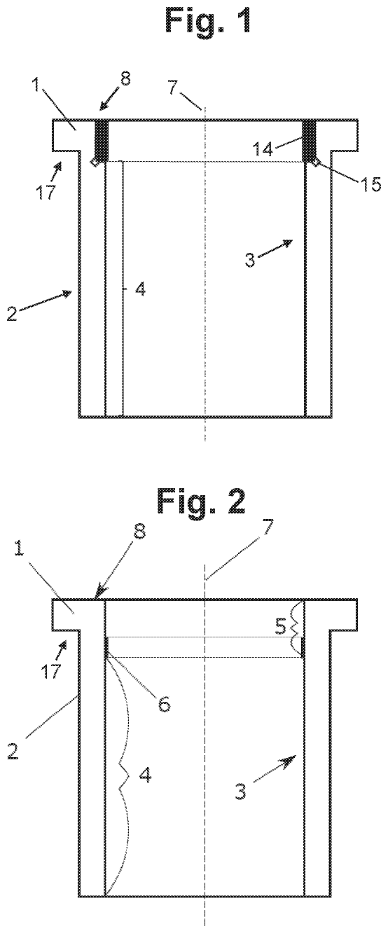

FIG. 1 illustrates an embodiment of a cylinder liner 1, wherein the cylinder liner 1 comprises an outer wall 2 configured to be fitted in a cylinder liner bore of a crank case 10 and an inner circular wall 3 forming at least partly a gliding surface 4 for a reciprocating piston 11 with at least one piston ring 12 during operation of the internal combustion engine.

At the front face 8 of the cylinder liner 1 (facing a cylinder head 13 in a mounted state of the cylinder liner 1), a recess 15 is provided to receive an anti-polishing ring 14.

The anti-polishing ring 14 is pressed into the recess 15 of the cylinder liner 1, wherein the recess 15 extends from the front face 8 of the cylinder liner 1 by a given length along the longitudinal axis 7 of the cylinder liner 1.

The inner wall 3 of the cylinder liner 1 is formed by turning, wherein the inner surface 3 can be finished after the turning process by honing.

The recess 15 is also formed by a turning process, wherein the inner wall 3 of the cylinder liner 1 having a defined diameter is enlarged to form a receiving area for the anti-polishing ring 14.

As it can be seen, the recess 15 does also include (for manufacturing reasons and for reducing mechanical stress inside the cylinder liner 1) an undercut, wherein between the recess 15 of the inner wall 3 and the anti-polishing ring 14 a cavity is formed.

In point of fact also between the recess 15 forming wall and the anti-polishing ring 14 small cavities are formed, because the anti-polishing ring 14 does not ever fit exactly into the recess 15 (as the manufacturing processes are never ideal), wherein further volumes are formed.

The formed volumes between the inner wall 3 and the anti-polishing ring 14 (crevice volume) are filled by an air-fuel-mixture present in the combustion chamber, because of the high pressures during the compression stroke.

During the combustion, this crevice volume is not reached by the ignition, wherein the compressed air-fuel-mixture is not combusted.

During a subsequent decompression (the exhaust stroke), the decompressed air-fuel-mixture is released into the exhaust manifold, wherein an increased HC-emission is caused by this crevice volume.

FIG. 2 discloses a first embodiment of a cylinder liner 1 according to the invention, wherein this embodiment of the cylinder liner 1 can be seen in FIG. 4 in a mounted state at a cylinder-piston unit 16.

The cylinder liner 1 of the first embodiment comprises an outer wall 2 configured to be fitted in a cylinder liner bore of a crank case 10, and an inner circular wall 3 having a diameter forming at least partly a gliding surface 4 for a reciprocating piston 11 with at least one piston ring 12 during operation of the internal combustion engine.

The cylinder liner 1 further comprises a front face 8 facing a cylinder head 13 in a mounted state of the cylinder liner 1.

In this embodiment (and the other embodiments), the front face 8 of the cylinder liner 1 is adjacent to a flange 17 for mounting the cylinder liner 1 in the cylinder-piston unit 16 of the internal combustion engine. In other embodiments, the front face 8 could be on the opposite side of the flange 17.

A part of an area 5 of the inner circular wall 3 is provided with a coating 6, which serves as an anti-polishing ring, wherein the area 5 extends along the longitudinal axis 7 of the cylinder liner 1 starting from the front face 8 along a length of maximally 20% of the diameter of the inner circular wall 3.

In some embodiments, especially when the coating 6 is applied only in a part of the area 5, which is not reached by the piston rings 12 during the operation of the internal combustion engine, it can be provided that the coating 6 extents along the longitudinal axis 7 of the cylinder liner 1 along a length of maximally 15% of the diameter of the inner circular wall 3.

As it can be seen, only a part of the area 5 is provided by the coating 6, wherein (as can be seen in FIG. 4) the part of the coating 6 covers that part of the inner wall 3, which is not reached by the piston ring 12 during reciprocation of the piston 11 (wherein FIG. 4 discloses an operating state of the cylinder-piston unit 16, wherein the piston 11 stays in top dead center TDC).

The coating 6 only covers an area 5 of the inner wall 3 between the front face 8 along the longitudinal axis 7 of the cylinder liner 1 until the piston ring 12 is closest to the cylinder head 13 of the piston 11 in the TDC of the piston 11.

By use of such a configuration of the coating 6, only the undesired volumes between piston 11 and inner wall 3 of the cylinder liner 1 are decreased, wherein the volume of the combustion chamber (formed by the inner wall 3, the piston crown 9, the cylinder head 13, and potentially a pre-combustion chamber) is not affected.

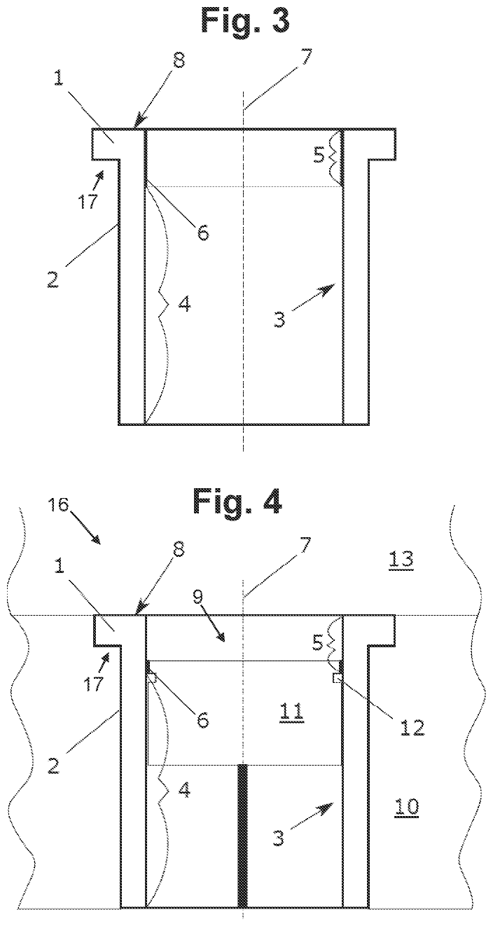

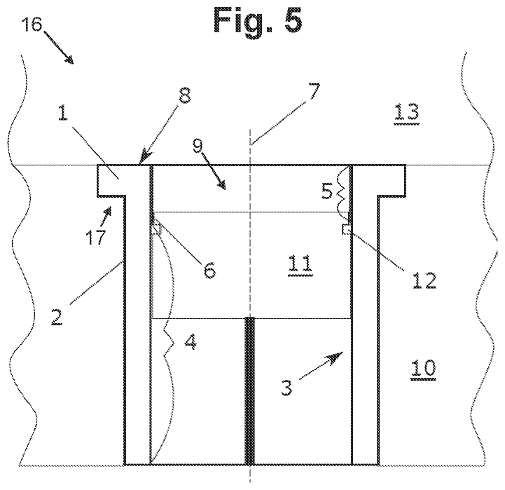

FIG. 3 shows a second embodiment of a cylinder liner 1 according to the invention, wherein this embodiment of the cylinder liner 1 can be seen in FIG. 5 in a mounted state at a cylinder-piston unit 16.

In comparison with the first embodiment disclosed by FIGS. 2 and 4, the second embodiment of FIGS. 3 and 5 comprises a coating 6, which extends from the front face 8 of the cylinder liner 1 circumferentially constant all the way down until the lowest point which is not reached by the piston 11 in operation of the cylinder-piston unit 16, during operation of the internal combustion engine.

Such an embodiment comprises the major advantage that the whole combustion chamber at a TDC of the piston 11 (in which the present compressed air-fuel-mixture is ignited) can be covered by the coating 6, wherein the combustion chamber or the wall which forms the combustion chamber can be covered by a coating 6 having especially favorable properties regarding thermal aspects.

### LIST OF USED REFERENCE SIGNS

1 cylinder liner
2 outer wall
3 inner wall
4 gliding surface
5 area of the inner wall
6 coating
7 longitudinal axis
8 front face
9 piston crown
10 crank case
11 piston
12 piston ring
13 cylinder head
14 anti-polishing ring
15 recess
16 cylinder-piston unit
17 flange

1. A system, comprising:
a cylinder liner configured to couple to an internal combustion engine, wherein the cylinder liner comprises an outer wall configured to be fitted in a cylinder liner bore of a crank case, and an inner circular wall forming at least partly a gliding surface for a reciprocating piston with at least one piston ring during operation of the internal combustion engine, wherein in at least a part of an area of the inner circular wall which is not reached by the at least one piston ring during reciprocation of the piston, a coating which serves as an anti-polishing ring is arranged.

2. The system of claim 1, wherein the inner circular wall comprises an inner diameter forming at least partly the gliding surface, wherein the cylinder liner comprises a front face facing a cylinder head in a mounted state of the cylinder liner, wherein the area extends along a longitudinal axis of the cylinder liner starting from the front face along a length of maximally 30% of the inner diameter of the inner circular wall.

3. The system of claim 1, wherein the thickness of the coating is in a range between 40 and 200 micrometers.

4. The system of claim 1, wherein the coating has an extension along a longitudinal axis of the cylinder liner in a range between 3 mm and 60 mm.

5. The system of claim 1, wherein the coating is arranged in an area of a top portion of the cylinder liner which is close to a cylinder head of the internal combustion engine when the cylinder liner is arranged in the cylinder liner bore of the crank case.

6. The system of claim 5, wherein the coating extends from a front face of the top portion of the cylinder liner to a distance 60 mm away from the front face along a longitudinal axis of the cylinder liner.

7. The system of claim 5, wherein the coating extends in a range of 57 mm to 60 mm away of a front face of the top portion of the cylinder liner.

8. The system of claim 1, wherein the coating is continuous around an entirety of the inner circular wall.

9. The system of claim 1, wherein the coating is applied directly onto the inner circular wall, wherein an entirety of the inner circular wall is a continuous surface along an entirety of a longitudinal axis of the cylinder liner.

10. The system of claim 1, wherein a material of the coating is Co-, Ti- or Ni-based alloy or ceramics.

11. A process for manufacturing the cylinder liner with the coating of claim 1, wherein the cylinder liner is manufactured via at least one manufacturing process from the group of casting, turning, milling or additive manufacturing, wherein an entirety of the inner circular wall is treated by a surface treatment process from the group of grinding or honing to create a specific surface roughness, wherein subsequent to the surface treatment process, the coating is applied via a weld cladding or brazing process only onto the at least one part of the area of the inner circular wall
which area is not reached by at least one piston ring during reciprocation of a piston, and/or
which area extends along the longitudinal axis of the cylinder liner starting from the front face along a length of maximally 30%, preferably maximally 20%, of the diameter of the inner circular wall.

12. The process of claim 11, wherein the coating is applied via a laser cladding process.

13. The process of claim 11, wherein the coating is post-treated by turning, milling, honing or grinding.

14. The process of claim 11, wherein the inner circular wall of the cylinder liner is manufactured with an essentially constant inner diameter by the at least one manufacturing process in a first step and wherein in a second step the coating is applied on the inner circular wall , wherein the inner diameter of the inner circular wall is decreased in the area by the coating.

15. The cylinder liner , obtainable by the process of claim 11.

16. The system of claim 1, comprising a cylinder-piston unit having the cylinder liner and the reciprocating piston with the at least one piston ring, wherein the at least one piston ring is distanced from a top surface of a piston crown of the reciprocating piston.

17. The system of claim 16, wherein the coating is distanced away in range between 0.1 and 2 mm from the at least one piston ring of the reciprocating piston along a longitudinal axis of the cylinder liner when the reciprocating piston is in a top dead center position and extends at least to the top surface of the piston crown.

18. The system of claim 16, comprising the internal combustion engine having the cylinder liner and the cylinder-piston unit.

19. A system, comprising:
a cylinder liner configured to mount into a cylinder liner bore of a crank case of an internal combustion engine, wherein the cylinder liner comprises:
an inner wall configured to receive a reciprocating piston;
a portion of an area of the inner wall is beyond a reach of a piston ring of the reciprocating piston during operation of the internal combustion engine; and
an anti-polishing coating disposed on the portion of the area of the inner wall.

20. A method, comprising:
forming a cylinder liner of an internal combustion engine, wherein the cylinder liner has an inner wall to receive a reciprocating piston, and a portion of an area of the inner wall is beyond a reach of a piston ring of the reciprocating piston during operation of the internal combustion engine; and
applying an anti-polishing coating on the portion of the area of the inner wall.
